(19) United States
(12) Patent Application Publication
(10) Pub. No.: US 2008/0149711 A1
(43) Pub. Date: Jun. 26, 2008

(54) Enhanced Automated Key Selection System

(76) Inventors: John Philip Griffits, Queensland (AU); Yvonne Sylvia, Queensland (AU)

Correspondence Address: JOHN PHILIP GRIFFITS, 99A TALLAI RD., TALLAI, 4213, omitted

(21) Appl. No.: 10/598,062

(22) PCT Filed: Feb. 25, 2005
(86) PCT No.: PCT/AU2005/000242

§ 371 Date: Aug. 17, 2006

(30) Foreign Application Priority Data
Feb. 25, 2004 (AU) 2004900928

(51) Int. Cl. G06K 19/00

(52) U.S. Cl. 235/385

(57) ABSTRACT

The present invention describes a method and system for attaching a plurality of lock keys to a key grouping device (e.g. key ring) that includes a) at least a first and second indicator means (preferably LED's) and b) a means of associating at least a first key with the first indicator and associating at least a second key with the second indicator, and c) a means to input information pertaining to one at least locks into electronics coupled to said key grouping device, wherein said lock(s) are preferably operable by one at least keys attached to the key grouping device, and d) a means to activate the indicator that is associated with the key that operates said lock to facilitate user selection of the correct key for said lock.

### INTRODUCTION

The present invention preferably seeks to describe as a non-limiting objective an electrically operable system to facilitate the use of keys for use with locks. The preferred keys for use with the invention are keys that include a mechanical key component. Mechanical keys are preferably those keys with one at least shapes formed onto one at least surfaces and/or edges of the key, said shape(s) preferably being essential to the operation of the target lock(s). Said essential formed shapes preferably distinguish said mechanical key from an electronic key where electrically readable stored content (for example, on magnetic strip and/or in semiconductor memory) coupled to said electronic key provides the essential information for operating the associated lock, even though the electronic information may be coupled an apparatus (eg credit card shape and size plastic apparatus) that needs to be a particular shape to couple with the electronics of the target lock. The invention seeks to expand on the means described in co-pending PCT AU03/001029, Titled “Identification and selection of keys for use with locks” by the present inventors. This document is incorporated into this specification by way of reference. The numbering used in the drawings of the present specification are not necessarily the same as those used in PCT AU03/001029.

### TERMINOLOGY

The use of one at least examples (or abbreviations for same) should be understood as meaning ‘one at least non-limiting example(s)’ The use of one at least examples in this specification preferably does not necessarily imply that said examples are essential to the invention, and/or preferably that said one at least examples (unless otherwise documented) are the preferred means. Furthermore when a plurality of examples are described it should be understood that in preferably one at least embodiment, none of said plurality may be used; and/or that in one at least embodiment preferably one at least of said plurality may be used. It should also be understood that the use of the singular of a word and/or phrase preferably may also be understood to reference the plural; and use of the plural preferably may be understood to reference the singular, where appropriate in the context used.

### DESCRIPTION

Co-pending PCT AU03/001029 describes a method of attaching an electrically readable Key ID device to a mechanical key, said device including an electrically operable indicator device, for example, LED. As a non-limiting example, when the key is attached to a key grouping device the activation of the indicator (eg illuminating said LED) is preferably used to facilitate user selection of the associated key from other keys that may be attached to the key grouping device. In this arrangement the indicator is clearly associated with the key by way of physical attachment, even when the key is removed from the key grouping device. The indicator of PCT AU03/001029 is preferably operable only when the key ID device is attached to the key grouping device, although allowance is made for an optional embodiment that incorporates power and control means into the Key ID device. Preferred methods of providing an electrically readable ID include one at least of a) RFID Transponder (for a solution that does not require an electrical connection to access digital information stored by said transponder) and/or b) an electronic device that operates using an electrical conductor for ground and at least a second electrical conductor that provides for the transfer of power, control information and data on a single conductor (for example Dallas Semiconductors ‘One Wire’ devices eg Dallas DS2401 Silicon Serial Number). The preceding examples provide a plurality of bits of digitally stored information that preferably may be used to provide part at least of a Key ID, such that a first digital ID attached to a first key is different to a second digital ID attached to a second key (and preferably different to a large number of other digital key ID's, that are preferably different to each other). The key ID device of PCT AU03/001029 preferably allows for indicia to be provided on an external surface of the key ID device, for example a bar code reader may be used to read a bar code on at least one surface of a key ID device. The key ID device of PCT AU03/001029 preferably allows for human readable indicia to be provided on one at least external surfaces of a key ID device. Examples of human readable indicia preferably include one at least of shapes, colours, text. Said human readable indicia preferably may also be electrically readable, for example, using a digital camera and image processor.

The present invention preferably may use part at least of the methods described in PCT AU03/001029 for providing a key ID device of the present invention. Part at least of the method of providing a key ID device in the present specification preferably may be used with part at least of the method and/or apparatus described in PCT AU03/001029.

The present invention seeks to describe as a non-limiting objective, a key ID device for association with a key(s), wherein,
said association preferably may include physical coupling, preferably using one at least of the following non-limiting methods:
   a) bonding (eg adhesive) said key ID device to its associated key(s),
   b) attaching said key ID device to its associated key by a restraining device (eg known art metal ring, comprising coiled metal with two free ends) that utilises i) a known art hole in said key and ii) a hole that is preferably in said key ID device;
   c) integrating said Key ID Device with its associated key during manufacture of said key.

A Key and associated Key ID Device that are physically coupled preferably may be referenced as a ‘Key ID Set’ or ‘KIDS’ in this specification.

The present invention seeks to describe as a preferred non-limiting objective at least one KIDS for use with a Key Grouping Device that is attached to one at least Indicator Devices, said Indictor Device(s) being for use with one at least said KIDS, and said Indicator Device remaining attached to said Key Grouping Device when one at least said KIDS is not attached to said Key Grouping Device. This is in contrast to the means described for PCT AU03/001029, wherein the Indicator Device is preferably an integral part of a KIDS (the combination of KIDS and Indicator Device is referenced as a Local Key Means of LKM in PCT AU03/001029) and does not remain attached to a Key Grouping Device when said KIDS is removed from said Key Grouping Device.

The present invention seeks to describe as a preferred non-limiting objective, a Key Grouping Device that does not include an Indicator Device as an integral part of said Key ID Device.

The present invention seeks to describe as a preferred non-limiting objective a method and apparatus to systematise the relationship between human readable indicia provided on the surface of one at least key ID devices and/or keys, and part at least of stored digital information pertaining to said Key ID device.
The preferred indicia are coloured shapes, preferably using colours that are reproducible and/or able to be approximated to, by at least one light source (eg LED's), said light source preferably being an Indicator Devices for use with the present invention.
   a) It is preferable that a primary coloured area(s) of at least a first colour is provided on a visible part of one at least key ID devices. It is preferable that said primary coloured area occupies a substantive amount of at least one surface of said key ID device.
      It is preferable that a first key ID device includes a primary coloured area of at least a first colour and a second key ID device includes a primary coloured area of a second colour, and a third key ID device includes a primary coloured area of a third colour, and a fourth key ID device includes a primary coloured area of a fourth colour. It is preferable that at least one of said first colour, second colour, third colour, and fourth colour are different to each other. It is preferable that the number of key ID devices distinguishable, in part at least, by way of primary coloured area is not limited.
   b) It is preferable that a second coloured area(s) of at least a first colour is provided on a visible part of one at least key ID devices. It is preferable said second coloured area occupies a smaller area that said primary coloured area. It is preferable that said second coloured area is distinguishable from said primary coloured area, preferably by way of different colour, in part at least.
   c) It is preferable that a third coloured area(s) of at least a first colour is provided on a visible part of one at least key ID devices. It is preferable said third coloured area occupies a smaller area that said primary coloured area. It is preferable that said third coloured area is distinguishable from said primary coloured area, preferably by way of different colour, in part at least.
   d) It is preferable that an n^{th} (where the numerical value of n is preferably not limited) coloured area(s) of at least a first colour is provided on a visible part of one at least key ID devices. It is preferable said nth coloured area occupies a smaller area that said primary coloured area. It is preferable that said nth coloured area is distinguishable from said primary coloured area, preferably by way of different colour, in part at least.
It is preferable that the colour(s) used for the primary coloured area have a relationship to one at least bit locations and/or digital content comprising a first bit group stored in digital format by an electrically operable device, wherein said primary coloured area and said electrically operable device are each components of the one key ID device. It is preferable that for a second coloured area forming part of said key ID device, that the colour(s) used for said second coloured area have a relationship to one at least bit locations and/or digital content of a second bit group stored in digital format by said electrically operable device, said second bit group locations preferably distinct to said first bit group locations. It is preferable that for a third coloured area forming part of said key ID device, that the colour(s) used for said third coloured area have a relationship to one at least bit locations and/or digital content of a third bit group stored in digital format by said electrically operable device. It is preferable that for an n^{th} coloured area forming part of said key ID device, that the colour(s) used for said n^{th} coloured area have a relationship to one at least bit locations and/or digital content of an n^{th} bit group stored in digital format by said electrically operable device. It is preferable that one at least bit groups of said first, second, third, through to the n^{th} bit groups, are comprised of bit locations that are distinct to one at least other bit groups of said first, second, third, through to the n^{th} bit group. It is preferable that the relationship between the colour(s) of one at least coloured areas and one at least bit positions and/or stored content is predetermined. It is preferable that the relationship between the colour(s) of one at least coloured areas and one at least bit positions and/or stored content is consistent across a plurality of randomly chosen key ID devices.

A preferred example method of predetermining the relationship between digital information in an electronic device that is for use with a key ID device and one or more coloured shapes on one at least visible surfaces of said key ID device is to preferably perform the following during the manufacture of said Key ID device:
a) read the digital content from said electronic device;
b) process some of said read information to determine which colour the primary coloured area of the target key ID device enclosure should be;
c) attach said electronic device to an enclosure that meets the colour criteria as determined;
d) process some of said read information to determine the colours of one at least other (eg, second, third and fourth) coloured areas that the surface of said enclosure should be provided with;
d) apply said coloured areas (eg pad printing as is known to the art of applying coloured shapes to plastic objects) to the surface of said key ID enclosure.

The invention preferably allows for the use of one at least known art methods and/or apparatus when used in conjunction with part at least of a key ID device described in the present specification. For example, the known art describes coloured and flexible devices (usually plastic or similar) that may be stretched over the handle of a key such that the device encloses part at least of the edge of said handle. It is preferable that said known art device of a particular colour(s) may be applied to a key that is associated (or will be associated) with a key ID device of the present invention that includes a primary coloured area that is the same of similar colour to said known art device.

There is preferably a means to attach a key ID device of the present invention to a key. There is preferably a means to attach a key ID device to a Key Grouping Device.

The use of the Key ID device of the present invention preferably provides a means to attach an electrically readable ID to mechanical keys that do not inherently have an electrically readable apparatus as an essential part of their operation, as is usually the case with known art electronic keys.

The invention preferably allows that mechanical keys may themselves act as an electrically readable Key ID device, for example, digital imaging and processing techniques may be used to recognise the key shape and/or formed shapes on one at least surfaces and/or edges of said key, using this information key ID information.

The invention preferably provides a means of transferring information that is associated with one at least keys and/or locks to an electrically operable device.
The electrically operable device preferably includes:
a) an electrically operable computer eg microprocessor, microcomputer, DSP, PC, PDA, and
b) computer readable media, eg i) semiconductor memory (eg DRAM, SRAM, Flash), ii) magnetic media (eg hard disk), optical (DVD, CD).
said electrically operable device is preferable not limited to the type of computer and/or computer readable media.

A preferred objective of the present invention is to describe a method and apparatus that provides for an electrically operable device, preferably a computer, to process digital information that is read from a key ID device to determine the nature of one at least human readable indicia associated with said key ID device (eg primary, second, third, and fourth coloured areas). The preferred method is to include a look up table in computer readable memory.

A preferred objective of the present invention is to describe a method and apparatus that provides for an electrically operable device, preferably a computer, that as non-limiting examples preferably may create, and/or copy, and/or transfer, and/or edit, and/or write to, and/or read from, information stored in computer readable media that pertains to one at least keys and/or locks, wherein said information pertaining to said key(s) and/or lock(s) preferably includes one at least of the following non-limiting examples:
a) part at least of the digital information content stored in an electrically operable device that forms part of i) the key ID device associated with said key and/or ii) the lock ID device associated with said lock;
b) information pertaining to one at least human readable indicia on one at least surfaces of said key ID device (eg the colour of one at least coloured areas) and/or lock ID device;
c) information pertaining to the lock(s) that said one at least key is able to operate (in part at least);
d) information pertaining to the key that said lock is operated by.

1) Said computer readable media preferably may include as non-limiting examples, computer readable media coupled to:
i) a key ID device, and/or
ii) a lock ID device, and/or
iii) a portable electronic device (eg PDA, cellular or mobile phone, electronic key fob, electrically operable key grouping device), and/or
iv) a user accessible computer (eg PC, portable, Internet connected computer) wherein said user access preferably includes an electrically operable display and/or electrically operable input means coupled (eg. wired and/or wireless) directly and/or indirectly to said computer, and/or
v) electrically operable key grouping device.

Information in a first computer readable media preferably may be transferred to one at least second computer readable media. Methods of transferring information preferably include one at least of optical, RF, IR, electrical conductor(s).

2) Said computer readable media preferably stores information pertaining to the direction that one at least humans should turn a key to action (lock and/or unlock) the associated lock(s).

3) Said computer readable media preferably stores information pertaining to the orientation of one at least keys relative to its associated lock(s) (eg is a shaped edge of a key up or down, for correct insertion into its associated lock or locks).

4) Said information pertaining to said lock(s) preferably includes information and/or facilitates access to information that facilitates one at least humans determining which lock (or locks) a particular key is operable with. Said facilitates preferably include as non-limiting examples a) the output of text, graphics, images on an electronic display; and/or b) machine generated voice (and/or other sound); and/or c) machine printed information; and/or d) illumination of one at least light sources (eg LED); and/or e) causing an electromechanical device to vibrate and/or protrude; and/or f) causing a key to protrude from an enclosure using an electrically operable force means (eg motor).
Non-limiting examples of text, image, graphics, and/or machine generated voice information preferably may include:
a) digital content information pertaining to digital content stored in one at least lock ID associated with one at least locks;
b) human readable indicia associated with said lock (eg on a lock ID associated with said lock, door number, room name);
c) descriptive (eg text and/or voice) and/or pictorial information (eg image, graphics) pertaining to one at least objects that one at least locks is coupled to (eg, filing cabinet, the colour(s) of a filing cabinet, the location of a filing cabinet (eg John's office), safe, cash box, desk drawer, front door, back door, bedroom window, vehicle 1 (eg picture of red jaguar), vehicle 2 (eg description of blue VW), boat);
d) descriptive and/or pictorial information pertaining to one at least objects that said lock is associated with (eg image of the building that encloses the filing cabinet that said lock is attached to, address of said building (eg street number, street name, suburb/city name, zip code), address of house that is attached to the front door that said lock is controls access to);
e) GPS co-ordinates of one at least locks and/or objects associated with said lock.

It is a preferred objective of the present invention to describe a Lock ID device (that is preferably electrically readable in part at least) for use with one at least KIDS, and/or Key ID devices and or Key Grouping Devices and or electrically operable devices that are coupled to computer readable media that provides part at least of the functions described for said media in this specification and/or said incorporated by reference PCT AU03/001029. Said Lock ID Device preferably may include part at least of the apparatus disclosed in said PCT AU03/001029 for a Lock ID means. Said coupling preferably may include wired (eg electrical conductors, fiberoptics, Onewire) and or wireless (eg RF (eg. Zigbee, Bluetooth, 802.11, RFID) coupling.

The invention preferably allows that information in electrically accessible format that is integral to a lock (eg electronic lock) may be used as lock ID information, if said information is accessible to an external device. In this instance the lock itself preferably may be considered to be an example of a Lock ID Device.

The preferred embodiment of a Lock ID device is an apparatus that includes electrically readable information, and/or human readable indicia (eg using one at least methods and/or apparatus described for a Key ID device), with said Lock ID device preferably being associated with a lock. A non-limiting example of said association is preferably by way of position of said Lock ID device relative to said lock, for example:
a) a Lock ID device attached to the door frame of the front door of a house is preferably recognised by a human observer as being associated with the lock of said front door rather than a lock locate further away, b) a Lock ID device attached to a filing cabinet is preferably recognised by a human observer as being associated with the lock(s) of said filing cabinet rather than the lock of an adjacent object, c) a lock ID device is preferably associated with the lock that it is closest to if an object includes plural locks, d) the Lock ID device preferably may include human readable indicia that facilitate association between said lock ID device and the associated lock (eg an indicia may read “Filing Cabinet” or “Front Door”). Human readable Indicia on a lock ID preferably may include text, images, graphics, shapes, as non-limiting examples.

One at least Lock ID devices is preferably provided (eg sold, rented, given) to a consumer for attachment to an object after said provision. As non-limiting examples said attachment is preferably by bonding (eg adhesive) and/or mechanical fixing (eg a screw or nail). Said attachment is preferably accomplished such that a human observer may associate said lock ID device with one at least locks.

The invention preferably allows that one at least Key ID devices and/or Lock ID devices may include at least one ‘glow in the dark’ material.

A preferred objective of the present invention is to describe a Key Grouping Device that includes means to input into, and/or output from said Key Grouping Device (and/or means coupled by wired and/or wireless means to said Key Grouping Device) information, that as non-limiting examples, preferably pertains to one at least of:
a) Key ID Device, and/or keys, and/or KIDS, and/or Lock ID devices;
b) Information pertaining to one at least locks and or objects said lock is associated with;
c) Information described in said PCT AU03/001029 for a Key Grouping Means, and/or Key Control means, and/or a device attached to said key grouping means.
Said input as non-limiting examples preferably may include one at least of keypad; voice input (eg to a microphone); user selection of objects (eg menu, text, images, graphics) on an electronic display; RFID methods; Onewire; RF (eg Zigbee and/or Bluetooth); IR; conductive methods; coupling to a computer (eg using a keyboard and/or USB port of a PC).
Said Key Grouping device and/or electrically operable devices coupled to said KGD preferably may electrically process said information. Said Key Grouping device preferably comprises at least:
a) an electrically operable device,
b) an apparatus for attaching a plurality of keys,
c) a plurality of electrically operable indicator devices, wherein said plurality preferably may be represented by a single indicator device that may operate in plural discernible states (eg at least a first colour at a first instant and a second colour at a second instant). Said Key Grouping Device preferably may activate and/or inactivate one at least indicator devices attached to said Key Grouping device. Said activation and/or inactivation is preferably facilitated by electronic processing of said input information. As an example, said activation preferably may facilitate user selection of one at least keys attached to said Key Grouping Device in preference to one at least other attached keys.

A preferred objective of the present invention is to describe a method and apparatus for transferring information from one at least of:
a) Key ID device,
b) Lock ID device,
c) Portable electronic device (eg cellular telephone, PDA, Key Grouping Device, Key Control Device),
d) Key Grouping Device,
e) Electrically operable device

A non-limiting example of a method of initialising an electrically operable apparatus (eg KGD, KIOD, personal computer) to facilitate the user selection of one at least keys attached a key grouping device, and/or user determination of the function of one at least keys, preferably includes one at least of the following method steps:
1) Attaching a Key ID device to an existing key, however the invention preferably allows that one at least keys may be supplied to one at least users with said Key ID device attached and/or otherwise integrated into said key.
2) Using an electrically operable device (eg KGD) to read information from said Key ID Device.
3) Storing said read Key ID information in computer readable media.
4) Storing information pertaining to one at least locks that said key(s) may operate in computer readable media such that an electrically operable device (eg computer) may subsequently associated said lock information with said Key ID information. Non-limiting examples of said information pertaining to locks preferably may include one at least of Lock ID digital content; descriptive and/or pictorial information pertaining said lock(s) and/or one at least objects associated with said lock(s); information pertaining to the direction to turn a key inserted into said lock in order to lock and/or unlock said lock; information facilitating correct insertion of a key into said lock (eg is a formed edge up or down).
Preferred methods of entering Lock information to said computer readable media preferably include one at least of:—a) using an RFID reader to read information from a Lock ID device that includes an RFID Transponder and the subsequent writing of said information to said computer readable media; b) reading information from a Onewire device that forms part of a Lock ID device and writing said information to said computer readable media; c) entering information using a keypad, d) selecting information displayed on an electronic display (eg a display coupled to said media); e) voice input of information; f) transferring information using automated means from another computer readable media.

To facilitate user determination of information pertaining to the lock(s) operable by a known KIDS, it is preferable that information stored by said KIDS is provided to an electrically operable device that has access to lock and key ID information previously stored in computer readable media. Said provision of Key ID Device information preferably may use any of the means described in the present specification and/or PCT AU03/001029 incorporated by reference.
Said information provided is preferably processed by an electrically operable device to determine if information pertaining to said key and/or the lock(s) operable by said key(s) have previously been stored in computer readable media coupled to said electrically operable device.
   a) The user is preferably advised (eg display and/or speaker means, illumination of one at least LED's in one at least colours) if said previously stored Key ID information is not accessible to said electrically operable device.
   b) If the Key ID information is accessible to said electrically operable device and said previously stored Lock information is not accessible, the user is preferably advised (eg display and/or speaker means, illumination of one at least LED's in one at least colours).
   c) If said previously stored Key and Lock ID information are both accessible to said electrically operable device, the user is preferably provided with information facilitating determination of the target lock(s) of said key (eg display means and/or speaker means describing the location of one at least target lock and/or one at least objects associated with said lock).

When a keys is to be attached to a Key Grouping Devices it is preferable that an electrically operable device may determine the electronic address of one at least indicator devices to be associated (eg by attaching the key in the vicinity of said indicator device) with said key and the appropriated indicator device(s) are preferably activated (eg LED(s) switched on). The invention preferably allows that an indicator device that illuminates when active may be caused to emit a first colour at a first instant and second colour at a second instant, and/or a third colour at a third instant, and/or a fourth colour at a fourth instant. It is preferably that an illuminable indicator device that is to be associated with a particular KIDS, illuminates in a colour that approximates at least the colour of one at least shapes (preferably the primary coloured shape) of said KIDS.
Said illumination preferably may be automatic (eg. using database of unused locations) and/or under user control (eg user may enter one at least key board commands to sequentially illuminate one at least Indicator devices, until the desired Indicator device is illuminated). The user preferably attaches the key to the KGD such that a reasonable human observer should be able to associate said key with said illuminable indicator(s) in preference to one at least other indicators attached to said KGD. The user preferably confirms (eg keyboard entry) that said key has been coupled to said KGD. The address of said Indicator Means is preferably associated with said KIDS in memory storage means accessible to said KDG. This information preferably may be edited subsequently.

When a user wants to determine the correct key to operate a selected lock(s) and said key is attached to (or thought to be attached) to a KGD that is also attached to one at least other keys that may not operate said lock(s), the invention preferably allows for the user to enter information associated with said lock into an electrically operable device associated with said KDG, preferably using part at least of the method and apparatus described in this specification and/or PCT AU03/001029 (eg RFID, Onewire, Digital Camera to read indicia). The user preferably may provide descriptive information pertaining to the lock (eg “Front door of 36 Smith St, Somewhere”). Said descriptive information preferably may include text and/or voice as non-limiting examples. The user preferably may select text and/or pictorial information presented on an electronic display to provide information about the lock they are seeking a key for (eg, a. scroll through a list of descriptive text and select appropriate description, and/or b. view images (eg car, filing cabinet, cash box)). Said associated electrically operable device preferably examines previously stored electrically accessible information to determine if said Lock information has previously been stored and if information (eg Key ID information) pertaining to one at least keys that may operate said lock has previously been stored. If the Lock ID information is not accessible the user is preferably advised (eg display and/or speaker means). The user preferably may be given the opportunity to enter information about one at least keys that may operate the lock coupled to said Lock ID. For example a user may visually scan keys coupled to one at least user accessible KGD and determine if a suitable key is attached. If no key is present they preferably may terminate the process (eg keyboard entry). If at least one appropriate key is coupled to one at least user accessible KGD, the user preferably may cause the KGD to illuminate (for example) the indicator means associated with the appropriate key(s). The Lock ID and Key ID means are then preferably electronically associated with one another in memory storage means. If one at least appropriate user accessible keys are not presently attached to one at least KGD, the user preferably may be able to activate the relevant processes to enter Key ID information into one at least KGD (if not previously entered) and preferably associate it with the previously scanned Lock ID information. If Lock ID information has previously been programmed into said KGD and/or coupled electrically operable device, and the Key ID information is not accessible, the user is preferably advised (eg display and/or speaker means). The user preferably may be provided the opportunity of entering the relevant key information and/or attaching said key to one at least KGD. If the Key ID and Lock ID information are both accessible to one at least KGD and/or coupled electrically operable device, the user is preferably provided with information facilitating determination of the relevant key. The preferred means with the present example is to illuminate the indicator device associated with the appropriate key. The invention preferably allows that plural indicator devices may be use to define a particular associated key, for example a key(s) may be attached to a KGD between a first and second indicator device and the illumination of both devices is a user signal that one at least of said keys is the correct key. The invention preferably allows that plural keys, each with indicia distinct to one at least others of said plurality (eg first key has red primary coloured area, second has green primary coloured area, third has orange primary coloured area, fourth has yellow primary coloured area) may be concurrently associated with one at least indicator devices, said indicator devices preferably able to illuminate differentially to select a particular key(s) with a particular indicia (eg illuminates red if the KIDS with a red primary colour is to be selected, green for a green primary coloured area KIDS, orange for an orange primary coloured KIDS and yellow for a yellow primary coloured KIDS. The invention preferably allows that the use of this type of indicator device may be considered to represent plural indicator devices in the one device—as a non-limiting preferred example:—when red is illuminated, said indicator device is acting as a First Indicator Device; when green is illuminated, said indicator device is acting as a Second Indicator Device; when orange is illuminated, said indicator device is acting as a Third Indicator Device, and when yellow is illuminated, said indicator device is acting as a Fourth Indicator Device.

The invention preferably allows for the use of key ID devices with human readable indicia as described in this specification that do not include an electronic device.

Said AU 03/01029 describes means for password protecting access to one at least functions of one at least electrically operable devices described by the invention eg KGD. The present invention preferably allows for a Password Protection Means dependent on the presence of one at least First Electronic Means (eg electronics attached to said KGD ) and one at least Second Electronic Means (eg Wristwatch), wherein one at least means of communication between said Second Means and said First means is preferably restricted in the normal course of use of both means, and said First and Second Means preferably may communicate to facilitate access to restricted functions coupled to one at least First Means and/or Second Means. Said Second Means is preferably physically separate to said First Means and preferably unlikely to be misplaced concurrently with said First Means should said misplacement occur. A non-limiting example of said Second Means preferably may include a watch that is attached to an RFID transponder and/or Onewire device. As a non-limiting example, one at least KGD preferably may activate part at least of its functions (eg automated key selection) when said Second Means is coupled (eg close enough for RF communication in the case of said RFID transponder, in electrical contact in the case of said Onewire device) with said KGD if the required information (eg digital content) is provided to said First means from said Second Means.

It is preferable that one at least Password Activation Means may be required for one at least KGD (as a non-limiting example) to commence communication with one at least Second Means. As a non-limiting example of said Password Activation Means, the user may need to press one at least keys coupled to said KGD to enable the RFID Reader coupled to said KGD. The invention preferably allows that one at least means activated by one at least Password Activation Means may be terminated (as a non-limiting example, said RFID reader preferably may automatically time-out after a predetermined period).

As a non-limiting example of a means for a user to enter information (eg a command) into electrically operable means described for the invention (eg KGD), the invention preferably allows for the length of time and/or number of times, one at least first electronic input and/or output means (eg RFID reader) may access (eg read) one at least second electronic input and/or output means (eg RFID transponder). This is referenced as Modulated Reader Input. For example the user may continually scan a Lock RFID Transponder and/or Watch Transponder for more than one second (for example) to indicate a first command input and less than a second (for example) to indicate a second command input. The invention preferably allows for a flashing illumination means (eg LED on enclosure of one at least KGD) to facilitate user timing of said Modulated Reader Input. The invention preferably allows for Modulated Reader Input (MRI) means to be used with other RFID and/or other electronic processing mean.

A described example of an Indicator Means is an Illumination Means (eg Light Emitting Diode). The invention preferably allows for other Indicator Means that as non-limiting examples preferably may include one at least of:
1. Vibrating Means.
2. Projecting Means (eg one at least Indicator Means may be a component (eg plastic) that pops up when active and may be retracted (preferably automatically) when inactive).
3. Audible Means.
4. The action of one at least keys being made available to the user may be an Indicator Means. For example, a key being made to project using automated means, said projection preferably may be one at least Indicator Means.

The present invention preferably seeks to describe a Security Check Validation Means to verify that one at least security personnel (as a non-limiting example) have attended one at least premises (as a non-limiting example) one at least times, and preferably the time or times of said attendance's. The means preferably may use part at least of the means allowed for in this specification (including means incorporated by way of reference). As a non-limiting example, one at least Key Control Means (KCM) preferably may include a secure processing means and/or secure real time clock/calendar means. One at least Lock ID Means coupled to said premises preferably may be written with information (eg writeable RFID Transponder). Said write preferably may be at plural times. A Second Write preferably may not modify part at least of a First Write. Written information preferably may be erased. Said erase is preferably password protected. For example, when the operator (for example) leaves the premises at night they may erase part at least of the information within said Lock ID Means (and/or other electronic means). One at least security personnel may subsequently attend said premises, and preferably perform a Visit Validation Process, that as a non limiting example preferably may include part at least of:

read said Lock ID (and/or other electronic means) into one at least Key Control Means (and/or other electronic means). One at least Public Key Encryption Codes pertaining to said Lock ID Means has preferably been previously entered into said Key Control Means (and/or other electronic means). Said KCM (and/or other electronic means) preferably reads, preferably tamperproof date/time, from said secure real time clock/calendar means, and preferably encrypts in said secure processing means, one at least of:—Lock ID Code; Current date, Current time, and/or Other Information, as non-limiting examples. The encrypted information is preferably written, in part at least to said Lock 1D Means (and/or other electronic means).

If said security personnel is required to perform one at least tasks at said premises, they preferably may be required to perform part at least of said Visit Validation Process when they complete said task (eg internal inspection). One at least security personnel preferably may be required to perform one at least subsequent Visit Validation Processes (eg if they check one at least premises on multiple after hours occasions).

Said operator (for example) preferably may return to said premises subsequent to said previous departure (eg the next morning), and preferably read the information written to said Lock ID Means by said one at least Security Personnel, preferably decode the stored information and verify the times that one at least Lock ID accesses (and presumably visits to said premise) took place. Said decoding preferably may include KCM processing and/or processing by one at least other processing means (eg PC). A record of this information preferably may be kept (eg in one at least KCM and/or PC's and/or Internet Means). Information captured by one at least KCM preferably may be transferred to one at least User Controlled Data Processing System's (eg PC) and/or to one at least Internet Means.

The present invention preferably seeks to describe a Key Tracking Means that as a non-limiting example preferably may electronically monitor to whom one at least keys has been issued (and preferably when); and/or the electronic ID of said one at least keys; and or/or whom as returned one at least said keys (and preferably when). As a non-limiting example, when one at least keys is issued to one at least persons, the Key ID is preferably read in to an electronic processing means (eg KCM). The details of the person(s) provide with said keys are preferably also entered (eg KCM keyboard entry, reading one at least RFID transponder means known to belong to said person(s), eg watch with transponder, security access means). The date/time of said issue is preferably concurrently stored. A similar process preferably may be used to record the return of one at least keys, including by whom and when. Information stored in said KCM (and/or other processing means) preferably may be transferred to (and/or from) one at least second processing means (eg PC and/or Internet)

The present invention preferably seeks to describe a Key Return Means to facilitate the return (as a non-limiting example) of one at least lost keys. As a non-limiting example, one at least key users preferably may register their details (eg name, address, telephone, fax, e-mail address) with one at least service providers) and one at least Key ID Means with one at least service providers. Lost keys preferably may be returned to said service provider, one at least lost Key ID means is preferably read by said service provider, and said key(s) preferably returned to their owner.

The present invention preferably seeks to describe an advertising means that preferably may be coupled to one at least Key ID Means, and/or Lock ID Means and/or Key Grouping Means and/or Key Control Means. As non-limiting example:—a) one at least Key Control Means preferably may include i) one at least web addresses (eg siliconsorcerers.com) on part of the external surface of its enclosure, and/or ii) one at least web addresses and/or advertising messages preferably may be displayed on one at least KCM Display Means part at least of the time; and/or b) One at least Key and/or Lock ID Means preferably may include advertising (eg one at least pharmaceutical item logos).

Preferred Embodiments described with reference to the drawings:

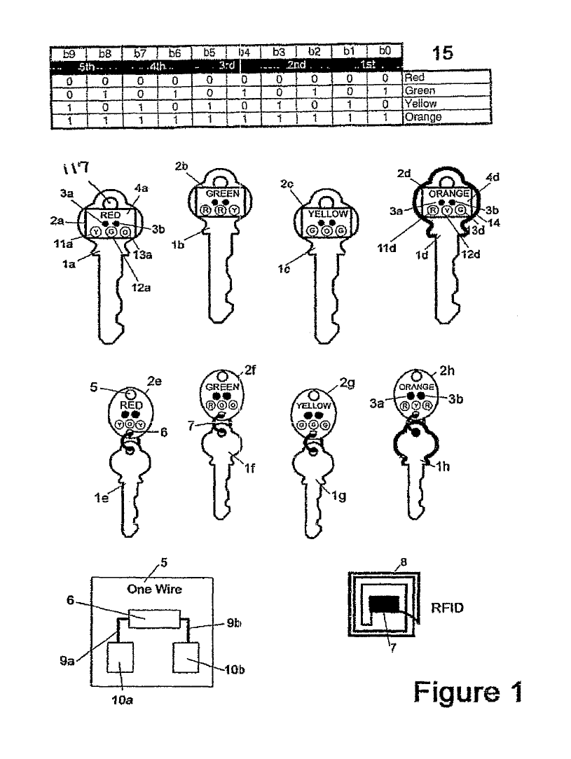

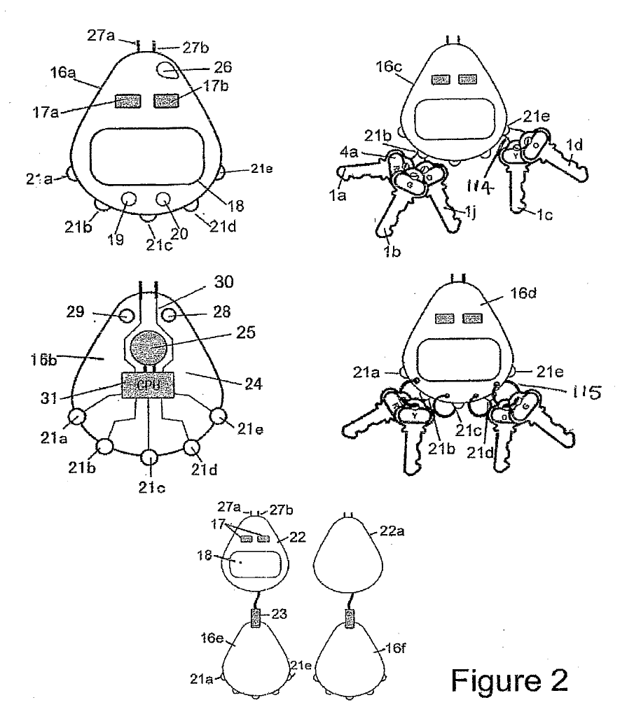

A preferred embodiment of the invention is described with reference to FIG. 1 of the drawings. Key 1a is shown with a key ID device 2a attached. The Key ID device 2a example comprises a substrate (preferably plastic that encloses Onewire device 6 that is preferably mounted on PCB 5. Onewire device 6 includes a ground pin that is connected by an electrical conductor 9a to a conductive ground pad 10a, and a second pin that is connected by electrical conductor 9b to a conductive second pad 10b. The second pin and the connected conductors 9b and 10b transfer power, control signals and data on a single conductor. The opening 3a in key ID device 2a provides access for a first external conductor (eg the ground line of an Onewire reader) to reversibly couple with the ground pad 10a. The opening 3b in key ID device 2a provides access for a second external conductor (eg the combined power, control signals and data signals of an Onewire reader) to reversibly couple with said second conductive pad 10a. Equivalent openings to 3a and 3b are depicted for Key ID devices 2b, 2c, 2d, 2e, 2f, 2g, and 2h.

The preferred method of attaching the preferred key ID devices of the types depicted as 2a, 2b, 2c and 2d to their associated keys 1a, 1b, 1c and 1d respectively is by adhesive. The adhesive is preferably applied prior to providing the key ID device to a consumer, preferably using known art means that preferably include a removable backing material to prevent inadvertent adherence of the key ID device. The key preferably may be provided to the consumer with the key ID device already attached.

Key ID device 2a depicts an example with a primary coloured area 4a that is red, a second coloured area 11a that is yellow, a third coloured area 12a that is green and a fourth coloured area 13a that is orange. Example key ID device 2b depicts a green primary coloured area, red second and third coloured areas, and a yellow fourth coloured area. Example key ID device 2c depicts a yellow primary coloured area, a green second coloured area, an orange third coloured area and a green fourth coloured area. Example key ID device 2d depicts an orange primary coloured area 4d, a red second coloured area 11d, a yellow third coloured area 12d and a green fourth coloured area 13d; this example also depicts an orange known art key ID means surrounding and attached to the handle of key 1d.

The preferred method of attaching the preferred key ID devices of the types depicted as 2e, 2f, 2g, and 2h is by a mechanical coupling to their associated keys (1e, 1f, 1g and 1h respectively). These are preferably similar to the key ID device examples 2a, 2b, 2c, and 2d, with regards to electronics, access to the electronics (eg 3a and 3b of key ID device 2h), substrate and coloured areas. The key ID device of examples 2e, 2f, 2g and 2h preferably do not use adhesive, they are preferably circular or oval shaped, there is preferably an opening 6 to attach the key ID device (2e, 2f, 2g and 2h) to the known art hole in the associated keys (1e, if, 1g, 1h), using an attaching device 7 (eg known art metal coils comprising one and a part turns of wire). The second hole 31 is preferably provided to permit the key ID device 2e to attach to a key grouping device (eg key ring).

The invention preferably allows that any suitable known art electronic device may be used to provide a method of storing and providing machine stored key ID information.

It is preferable that the Onewire means described may be replaced by an RFID transponder that preferably comprises at least a readable transponder 7 and coil 8. These are preferably embedded in the substrate of the key ID device as described for Onewire apparatus. This method does not require electrical contact and openings 3a and 3b are preferably not provided in an RFID embodiment of a key ID device.

For a key ID device comprising a) one or more coloured areas (eg 4a, 11a, 12a, 13a) and b) digitally stored information in an electrically operable device (eg Onewire integrated circuit 6), Table 15 of FIG. 1 depicts an example method for associating said coloured areas with said digital information. In this example bits b0 and b1 are associated with the primary coloured area of the key ID device. For example, if b1 and b0 are zero, the associated primary coloured area is preferably red. The primary coloured area is preferably Green if b1=0 and b0=1; Yellow if b1=1 and b=0; and Orange if b1=1 and b0=1. A similar system is preferably used for other coloured areas (eg second area is coded by b2&b3, third area by b4&b5, fourth area by b6&b7 and fifth area by b8&b9). This method preferably enables a suitably programmed electronic device (eg microprocessor, PC) to read the electronically stored digital information from a key ID device and to automatically determine the colours of one or more coloured areas associated with said key ID device.

It is preferable that an electrically operable device (eg computer) that reads the digitally stored information from a key ID device 2a includes a method of using said read information to associate one at least human readable indicia (eg coloured areas 4a, 11a, 12a, and 13a) with said information. The preferred method is to include a lookup table in computer readable memory that is coupled to, said electrically operable device (eg computer). For example the colour coding cross referenced with digital information of table 15 preferably may be programmed into said computer readable media and used as part at least of said lookup table.

FIG. Two of the drawing show non-limiting examples of preferred embodiments of key grouping devices. KGD 16a depicts a KGD that includes a means to interface with an Onewire device, showing ground pin 27a and combination power, data and control conductor 27b. A means to attach said KGD to another object eg belt, another KGD is preferably provided, for example hole 26. One or more key 17a, 17b are preferably provided to provide for user input. An electrically operable display (eg LCD, OLED, OLEP) 18 is preferably provided to allow for provision of text and/or pictorial information to the user. An apparatus for inputting voice 19 (eg microphone) and/or outputting sound 20 (eg speaker) is preferably allowed for. The KGD 16a is preferably coupled to a plurality of indicator devices, with the preferred indicator devices being electrically operable light sources (eg LED, OLED, OLEP) 21a, 21b, 21c, 21d, 21d, 21e as non-limiting examples. The KDG of 16b show a non-limiting example of an internal view, that in this example, include RF (eg Zigbee and/or Bluetooth) 29 and/or IR 30 devices to communicate with other devices (eg another KGD, a portable electrically operable device, a personal computer, an electrically operable device connected to the internet). KGD 16a preferably includes a power source 25 (eg battery) and computer 31 (eg microprocessor, DSP) that is preferably coupled to electrically operable computer media (not shown). KGD 16c depicts an example with a plurality of keys attached via a key restraining device 114 that is preferably a flexible and resilient device (eg wire reinforced plastic). In this example embodiment the keys are associated with particular indicator means—keys 1a, 1b and 1j are associated with indicator means 21b, and keys 1c and 1d are associated with indicator means 21e. The indicator means 21b and 21e are LED's in this non-limiting example (they preferably may be any type and/or mix of known electrically operable light sources, and/or any other indicator means allowed for by the invention—eg vibrating and/or sound for the visually impaired). LED 21b preferably may be illuminated in at least a first colour at a first instant and a second colour at a second instant. LED 21e preferably may illuminate in a first colour at a first instant and a second colour at a second instant. It is preferable that the number of different colours that one at least indicator may emit at different times is not limited. The invention preferably allows that an indicator device may only illuminate in a single colour. In the present example, LED 21b will be red if key la that is attached to red Key ID device 4a is the correct key for a particular user selected lock; similarly LED 21b preferably illuminates green to select key 1b, and orange to select key 1j. LED 21e illuminates orange to select key Id and illuminates yellow to select key 1c. KGD 16d depicts another example embodiment, wherein the keys are attached to KGD 16d using known art metal rings in common use for coupling keys to a key ring. In this example one at least keys are associated with a plurality of indicator devices, for example LED 21a and 21b preferably illuminate to select the red and yellow colour coded keys (preferably both red to select the red key, and both preferably yellow to select the yellow key). A similar method preferably applies to the orange and green keys associated with LED's 21d and 21e. KGD 16e shows another preferred embodiment—in this case the KGD 16e preferably includes the computer and indicator means, with part of the functions included in Key Input and/or Output Device (KIOD) 22 that preferably may include a power source (not shown) display 18, keypad 17, interface to Onewire 27a, 27b and a device to couple to said KGD 16e. The KIOD is preferable removable from said KGD 16e. The KIOD preferably may include part at least of the method and/or apparatus described for a Key Control Means in PCT AU03/001029.

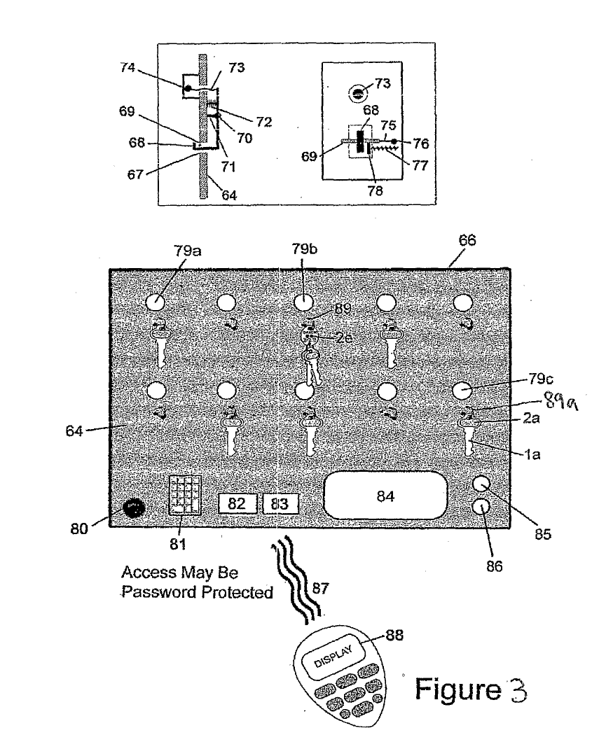

FIG. 3 of the drawings depicts a non-limiting example of a fixed key grouping device 64 (eg a wall mounted board. The keys for use with said fixed KGD 64 are preferably attached to a key ID device described for the invention (eg key 1a and Key ID device 2a). KGD 64 preferably includes indicator devices (eg 79a, 79b, 79c) that are preferably associated with a device to attach one at least keys in such a manner that said key(s) are visibly associated with a particular indicator device(s). It is preferable that said KGD 64 includes apparatus to input information to an electrically operable device(s) associated with said KGD 64 and to output information from said electrically operable device(s). For example, voice information preferably may be provided via microphone 80, information preferably may be keyed in using key pad 81, RF 82 and/or IR interface 83 preferably allow for wireless communication to and/or from said associated electrically operable device(s); electronic display 84 preferably provides for example, output of text and/or pictorial information; RFID reader 86 preferably allows for direct input of key and/or lock id information stored in RFID transponders and Onewire reader 85 preferably allows for the direct input of key and/or lock ID information stored in a Onewire device. The invention preferably allows for a portable electronic device 88 (eg portable KGD, portable KIOD) to transfer information to and/or from electrically operable devices coupled to said fixed KGD 64. As a non-limiting example, it is preferable that when a user wants to attach a key 1a to said KGD 64 that they couple said key to an apparatus that permits input of machine readable information from the key ID device 2a to an electrically operable device(s) coupled to said KGD 64. For example a KIDS that includes a Onewire device preferably by couple to Onewire reader 85 and a KIDS that includes an RFID transponder is preferably coupled to RFID Reader 86. A group of keys sharing a common Key ID Device 2e is depicted, said group preferably behaving as described for discrete keys. After acquiring said Key ID content information, one at least indicator devices 2a preferably illuminates to indicate that the key is to be attached to hook 89a, associating it with indicator 79c. Electrically operable devices coupled to said KGD 64 preferably may store information pertaining to one at least Lock ID devices associated with one at least key ID devices, When a user requires one at least keys to be removed from KGD 64, they preferably provide key information pertaining to said key (eg using one of the input devices of FIG. 3) and/or information pertaining to the lock that said key(s) operate. Said lock information preferably may be transferred to said KGD 64 using portable electrically operated device 88 (eg a portable KGD that has electrically read a user selected lock). KGD 64 preferably includes an apparatus to restrict attachment and/or removal of keys to and/or from said KGD 64. Key attachment device 68 preferably can be moved in and out of slot 67 in KGD and held locked by retaining means 69. Opening said attachment device 68 is preferably achieved by Shape Memory Wires SMA 73 (eg Nitinol) being heated (eg by electric current) to pull on 68 at point 73, that pivots on 70 and preferably may be closed by spring 72, and SMA 75 that removes locking device 69 that is pushed locked again by spring 77 when SMA cools and may be stretched. Operation of the electromechanical apparatus is preferably controlled by electrically operable devices coupled to KGD 64.

It is understood that variations in the figures or described elsewhere in this specification are for illustrative purposes only and that many other variations will be apparent to one skilled in the art. It will also be understood that the specification and figures are illustrative of the present invention and that other embodiments within the spirit and scope of the invention will suggest themselves to those skilled in the art.

1-46. (canceled)

47. A systematically determined colour coded key ID comprising a colour content signal, wherein:
the signal is usable by a person, and
the colour content comprises at least one colour, and
the colour coded key ID is physically coupled to a key and or for physical coupling to a key.

48. A systematically determined colour coded key ID as claimed in claim 47 wherein at least part of the colour content signal is provided by a first characteristic region of the colour coded key ID and the colour content provided by the first characteristic region comprises at least one colour that is a member of a group of distinctive colours usable with the system and wherein the characterization of the region comprises at least one of colour, shape, size or position.

49. A systematically determined colour coded key ID as claimed in claim 48 wherein the colour coded key ID is for use with an electrically operable system arranged to:
receive information related to a lock operable by the key and
output colour information associable with colour content provided by said first characteristic region.

50. A systematically determined colour coded key ID as claimed in claim 48 further comprising at least one of:
a second, and preferably third and preferably fourth characteristic region of the colour coded key ID:
wherein part of the colour content signal is contributed to by each implemented second, third and or fourth characteristic regions and
the colour content provided by each implemented characteristic region comprises at least one colour that is a member of said group of distinctive colours. and
wherein the characterization of the implemented characteristic regions each comprise at least one of colour, shape, size or position.

51. A systematically determined colour coded key ID as claimed in claim 50 wherein the area of the first characteristic region is larger than each implemented second, third and or fourth characteristic region.

52. A systematically determined colour coded key ID as claimed in claim 47 further comprising information related to the colour content of the signal wherein the information is readable by an electrically operable device and preferably wherein the information is stored in a digital format.

53. A systematically determined colour coded key ID as claimed in claim 52 wherein said information readable by an electrically operable device is for transfer to a computer arranged to use the transferred information to determine information pertaining to the colour content of the signal.

54. A systematically determined colour coded key ID as claimed in claim 52 wherein said information readable by an electrically operable device is stored in electrically operable memory accessible using at least one of: RFID or the transfer of data on the same electrical conductor providing power to the electrically operable memory.

55. A systematically determined colour coded key ID as claimed in claim 48 further comprising information related to the colour content of the signal wherein the information is stored in a digital format and the information comprises at least one predetermined bit location in the digital format, said location or locations associable with the colour content of the signal pertaining to said first characteristic region.

56. A systematically determined colour coded key ID as claimed in claim 55 wherein the predetermined bit location or locations pertaining to the first characteristic region is consistent for a plurality of colour coded key ID.

57. A systematically determined colour coded key ID as claimed in claim 56 wherein the digital content of the predetermined at least one bit location pertaining to the first characteristic region is a first content for a first member of said group of distinguishable colours and a second content for a second member of said group, said first and second content preferably distinct.

58. A systematically determined colour coded key ID as claimed in claim 50 further comprising information related to the colour content of the signal wherein the information is stored in a digital format and the information comprises at least one predetermined bit location of said digital format that is associable with the colour content of the signal pertaining to said first characteristic region and at least one predetermined bit location of said digital format that is associable with the colour content of the signal pertaining to said second characteristic region, wherein said bit location or locations pertaining to the first characteristic region are distinct to the bit location or locations pertaining to the second characteristic region.

59. A systematically determined colour coded key ID as claimed in claim 58 wherein the digital content of the predetermined at least one bit location pertaining to the first and or second characteristic region is a first content for a first member of said group of distinguishable colours and a second content for a second member of said group, said first and second content preferably distinct.

60. A systematically determined colour coded key ID as claimed in claim 47 wherein the system provides for a predetermined systematic arrangement to store information pertaining to said signal in computer accessible memory of a computer and preferably wherein the computer is integral to a portable electrically operable key grouping device.

61. A systematically determined colour coded key ID as claimed in claim 60 wherein the information pertaining to the signal includes information relating to at least a first colour comprising said colour content.

62. A systematically determined colour coded key ID as claimed in claim 61 wherein the first colour is a member of a group of distinctive colours usable with the system and preferably wherein the arrangement to store information comprises a digital format with first content for a first colour of a first distinctive colour of said group and second content for a first colour of a second distinctive colour of said group.

63. A systematically determined colour coded key ID as claimed in claim 60 wherein the signal comprises colour content of at least a first and second colour,
wherein:
the first colour is provided by a first characteristic region of the colour coded key ID and
the second colour is provided by a second characteristic region of the colour coded key ID and
the information pertaining to the signal includes information used to determine the colour of said first characteristic region and the colour of said second characteristic region.

64. The systematically determined colour coded key ID as claimed in claim 63 wherein the first and second colours are members of a group of distinctive colours usable with the system; and
preferably wherein the arrangement to store information comprises a digital content of:
first content for:
a first colour of a colour of a first member of said group and
a second colour of a colour of a second member of said group, and
second content for:
a first colour of a colour of a second member of said group and
a second colour of a first distinctive colour of said group, and
the first and second content are preferably distinct.

65. The systematically determined colour coded key ID as claimed in claim 60 wherein the colour coded key ID is referenced as a first colour coded key ID and the computer is further arranged to provide a systematic arrangement to derive colour content information from said stored information related to the first colour coded key ID whereby the colour content information pertains to the colour content signal.

66. The systematically determined colour coded key ID as claimed in claim 65 wherein the computer is further arranged to derive colour content information from stored information pertaining to a second colour coded key ID sharing the system of the first colour coded key ID wherein the colour content information pertains to the colour content signal of the second colour coded key ID.

67. An electrically operable system comprising a computer, an electrically operable display and computer accessible memory wherein the memory stores:
information related to at least a first key and a first lock operable by the first key, and information facilitating the storage and or determination of colour coded information physically coupled to at least said first key.

68. An electrically operable system as claimed in claim 67 wherein the colour coded information physically coupled to the key is systematically determined.

69. An electrically operable system as claimed in claim 68 wherein the key is physically coupled to digital content related to the colour coded information and preferably wherein said digital content is systematically determined.

70. An electrically operable system as claimed in claim 67 wherein the information facilitating the storage and or determination of colour coded information physically coupled to said first key comprises digital content systematically associable with at least one of:
a first, second, third and or fourth characteristic coloured region pertaining to said colour coded information.

71. An electrically operable system as claimed in claim 70 wherein said digital content is systematically associable with a plurality of colour coded key ID's physically coupled to a plurality of respective keys.

72. An electrically operable system as claimed in claim 67 integral in part at least to one of: PDA, mobile phone, cellular phone, electronic key fob, portable key grouping device, personal computer, a computer coupled to the internet.

73. An electrically operable system as claimed in claim 67 further comprising at least one device to transfer information by wire and or wireless to a second computer.

74. An electrically operable system for identifying at least a first key for an associated first lock and a second key for an associated second lock comprising:
an electrically operable first indicator providing first colour information for identifying the first key and
at least one electronic device responsive to a signal associated with the first lock for activating the indicator to identify the first key, and
an electrically operable second indicator providing second colour information for identifying the second key and
at least one electronic device responsive to a signal associated with the second lock for activating the indicator to identify the second key.

75. An electrically operable system as claimed in claim 74 wherein the first and or second keys are attached to the system.

76. An electrically operable system as claimed in claim 74 wherein the first and second indicator are located at distinguishable positions and the first indicator is for association with the first key preferentially to the second key and the second indicator is for association with the second key preferentially to the first key.

77. An electrically operable system as claimed in claim 76 wherein the first and or second indicator independently produce a first distinguishable colour at a first time and a second distinguishable colour at a second time and preferably wherein at least one distinguishable colour related to the first indicator is distinct to at least one distinguishable colour related to the second indicator.

78. An electrically operable system as claimed in claim 77 wherein:
the first indicator is for association with at least one key additional to the first key and the first key is colour coded with a colour associable with said first distinguishable colour and the additional key is colour coded with a colour associable with said second distinguishable colour; and or
the second indicator is for association with at least one key additional to the second key and the second key is colour coded with a colour associable with said first distinguishable colour and the additional key is colour coded with a colour associable with said second distinguishable colour.

79. An electrically operable system as claimed in claim 74 wherein the first and second indicators are provided in part at least by a shared location providing distinguishable: first colour information at a first time and second colour information at a second time.

80. An electrically operable system as claimed in claim 79 wherein the first key is associable with the first colour information and the second key is associable with the second colour information.

81. An electrically operable system as claimed in claim 80 wherein the first key is colour coded with a colour associable with the first colour information and the second key is colour coded with a colour associable with the second colour information.

82. An electrically operable system as claimed in claim 81 further comprising at least one of: PDA, mobile phone, cellular phone, electronic key fob, portable key grouping device, personal computer.
